(19) United States
(12) Patent Application Publication
(10) Pub. No.: US 2007/0294883 A1
(43) Pub. Date: Dec. 27, 2007

(54) Apparatus for the processing of photovoltaic cells

(75) Inventor: Georg Napetschnig, Diex (AT)

Correspondence Address: TIAJOLOFF & KELLY, CHRYSLER BUILDING, 37TH FLOOR, 405 LEXINGTON AVENUE, NEW YORK, NY, 10174, US

(73) Assignee: KIOTO Clear Energy AG, Klagenfurt (AT)

(21) Appl. No.: 11/807,924

(22) Filed: May 30, 2007

(30) Foreign Application Priority Data
Jun. 1, 2006 (EP) EP 06 114 838.3

(51) Int. Cl. B23P 19/10

(52) U.S. Cl. 29/743

(57) ABSTRACT

The apparatus according to the invention concerns a production line (1) for the automated processing of individual photocells (11) for the production of strings (17) where the individual photocells (11) are taken up by means of a suction pad gripper (10) from a supply magazine (3) and moved to a centering unit, subsequently pass through a soldering station (15) where they are connected with crimped, electrically conductive metallic connectors (8) in series to one another, and the completed strings (17) being removed from the production line (1) by a string lifter (16). It is distinguished by the fact that it can process photocells (11) of varying dimensions and thicknesses and that transportation through the production line is accomplished exclusively by means of vacuum.

### FIELD OF THE INVENTION

The present invention concerns an apparatus for the processing of photovoltaic cells for the manufacture of solar modules It is distinguished by the fact that it is suitable for the processing of photovoltaic cells of varying thicknesses and varying dimensions.

### BACKGROUND OF THE INVENTION

Photocells exist in the most diverse sizes and with varying thicknesses of the crystalline silicon layer on the carrier wafer. Commonly available photocells currently come as thin rectangular or square plates with sides ranging in length from 50 mm to 200 mm and a thickness of the crystalline layer ranging from 300 μm to 160 μm. It appears that future developments point toward ever larger plates with even smaller thicknesses.

Prior art automated devices for the processing of photocells are each designed for one particular photocell type and therefore cannot react with sufficient flexibility to new developments in the industry. Furthermore, automated production lines are very costly which means that they are economically useful only when operated for long periods with correspondingly high numbers of units produced.

Moreover, there is also tie problem of photocells being very susceptible to mechanical damage, e.g. by grippers, positioning stops, turntables, and the like.

When individual photocells are processed they are connected by electrically conductive connectors into so-called strings or chains, which increase the voltage of the individual photocells to a useful level by being connected in series, and are in turn connected together. Under prior art, in connecting, for example, 5 or 10 individual photocells into a string, short, electrically conductive solder strips are permanently affixed on the photocells which already have a comb or grid-like pattern of contact paths printed upon them. This is usually done by soldering. Since the contact points or surfaces of the individual photocells are located in different areas of the various types of photocells it is necessary in automated devices to bring the contact strips to these contact points in the simplest way possible. An exact positioning of the parts is necessary for this, especially of the photocells, which themselves may exhibit production tolerances.

Because high processing rates are desirable in order to manufacture as high a number of strings as possible in the shortest possible time, photocells have been until now moved at high speed up to stops which are in most cases made of durable materials such as steel to prevent rapid wear by the sharp silicon edges. However, photocells are very fragile and the material used to make the stops frequently causes the edges to break, and in the worst cases creates hairline fractures in the photocell. Since the completed strings are simultaneously combined into modules between glass plates or similar weatherproof encapsulation, they cannot be replaced later. Therefore, installation of even one single faulty photocell makes a large, expensively manufactured, module unusable.

In order to prevent such problems during the exact positioning of photocells, in known devices the individual photocells are lifted by a suction device from a supply magazine and precisely positioned in a centering device, in most cases by means of an opto-electronic positioning means, before they are conveyed to the soldering location. The precisely preset, reproducible final position of the supplied connector serves as the reference point. The connectors are attached by soldering at the front and back sides of the photocells after being coated with soldering flux from a soldering flux dispenser, or by an etching substance from a nozzle. They are next turned over so that the excess soldering pretreatment material is removed by the mechanical turning of the connectors, because the material could cause problems in the subsequent encapsulation of the strings.

The connectors employed are only a few centimeters long and 1 to 2 mm wide. According to prior art they are first coated with solder pretreatment materials from the top on the side which will be the underside. They are then turned over and held in place by vacuum in a transport device and brought to the soldering station in this position. The actual soldering process by means of radiant soldering then takes place by heating the entire photocell with the positioned connector to a temperature at which the solder paste melts. The growing string is moved out of the soldering station by a lift beam system combined with a belt transport device and is brought to a string storage table.

Another source describes a process and device for the manufacture of solar cells where in a similar fashion the photocells are subjected to processing while positioned with the sun sides, i.e., the sides of the photocells that in the completed photoelectric device will face the light source and/or are configured to receive light to be converted to electrical energy, downward. By having the sun side facing downward, a subsequent turning over of the completed string is avoided. The photocells are removed from a supply magazine by means of a suction device, transported to an inspection station and subsequently moved, arranged in a row, to have the electrically conductive connecting strip soldered on. The first half-length of the crimped strip is soldered onto the upward facing underside of the photocell, and its second half-length is soldered onto the downward facing sun side of the following photocell. There is a small gap between the photocells. The connecting strip has a width of 3 mm and a thickness of 0.2 mm. By means of another suction transport device, the soldered strings are superimposed, with the sun side facing down, on a chain track conveyor acting as a step-by-step conveyor, and the soldering connections protruding over the two frontal ends of the strings on the conveyor are connected by soldering. A plate or something similar can be substituted for the chain track conveyor.

For further processing, the joined strings, which extend over a part or the entire area of the chain conveyor, are lifted by another suction conveyor from the chain conveyor and placed between glass-laminated EVA foils. The glass-foil-string package created in this fashion is transported, in sandwich-like superimposed layers, to an oven for the baking of the foils. Of course, during the transport of the soldered strings by the suction conveyor, the photocells are exposed to only minimal mechanical forces, thus preventing mechanical damage.

However, all of these known systems have the decisive disadvantage that the total string lengths can exceed the established tolerance of less than 1 mm. During the transport of the individual photocells to the soldering station, through the said station and during the subsequent removal therefrom, minor displacements can take place which can be additionally increased by the heat transmission.

Another considerable disadvantage of the known devices for the production of photocells is that they are designed only for a specific size of photocell plates. In the event of a photocell plate size change they can only be reconfigured at great engineering cost, if at all

The known devices exhibit similar problems when photocell plate thickness is reduced. For economic reasons, ever thinner photocell plates are being developed, but their use in known fully automated systems of the generic kind according to the invention does not lead to satisfactory results because such thin plates in most cases cannot withstand the mechanical loads therein, and as a result the breakage rate is excessive.

### SUMMARY OF THE INVENTION

To avoid these disadvantages of the known prior art, an object of the present invention is to provide an apparatus for automated photocell processing for the production of photocell strings where the total string length of the completed string does not exceed the established tolerance range of 1 mm or less, and which is suitable for the processing of photocells having varying plate surface sizes and thicknesses.

The object is achieved by an apparatus for the automated processing of individual photocells (11) for the production of strings (17) where the individual photocells (11) are removed from a supply magazine (3) by means of a vacuum pad gripper (10), and are moved to a centering unit and subsequently pass through a soldering device (15) where they are joined in series by electrically conductive metallic connectors (8) and the completed strings (17) are removed by a string lifter (16) from the processing line. The photocells (11) are preferably gripped by the vacuum pad gripper (10) with their sun side facing up and are deposited on a centering device which is provided with optical sensors. The centering is executed relative to the outer edge of the photocell (11) and/or the sun-side mounted collector bus of the collector, that a full plate vacuum pad suction device (12) removes the photocells (11) from the centering unit and deposits them on a conveyor (13) with through openings (14) functionally connected with a vacuum device, and that the conveyor(13) transports the photocells (11) or the growing string (17) through the remaining portion of the processing line (1) up to the removal of the string (17) by the vacuum-operated string lifter (16).

Advantageous developments are found in an apparatus with the technical features of claim 1 or claim 14, and others are the subject of the dependent claims.

### BRIEF DESCRIPTION OF THE DRAWINGS

A possible embodiment of the invention is explained in more detail by way of the drawings.

FIG. 1 schematically shows the structure of the apparatus according to the invention.

FIG. 2 shows in detail the photocell receiving magazine with the holding devices.

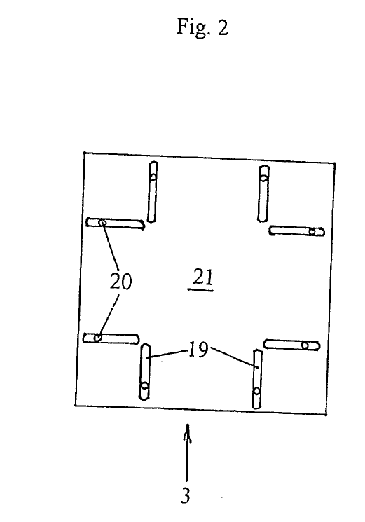

### DETAILED DESCRIPTION

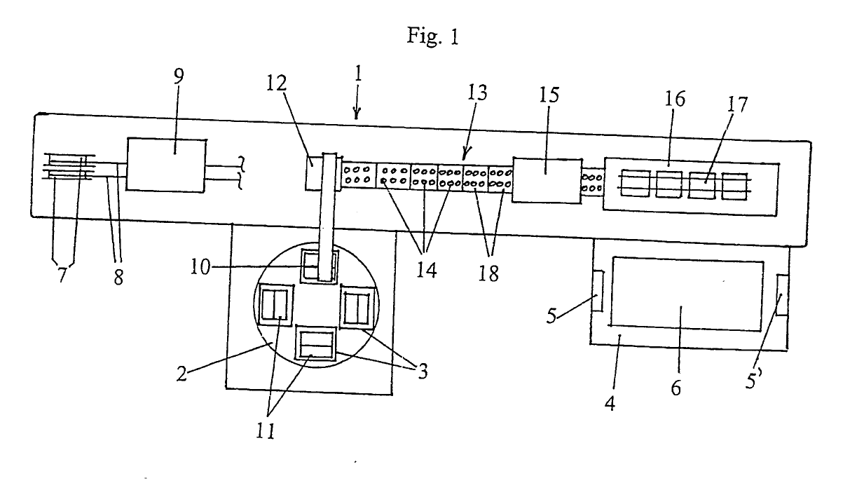

The apparatus according to the invention shown in FIG. 1 comprises a substantially linear production line 1, a laterally attached turntable 2 with a plurality of magazines 3, and a laterally attached receiving table 4, with inspection devices 5 and 6, for the completed photocells. Electrically conductive connectors 8 are retrieved from supply rolls 7, coated with a soldering preparation and pretreated in a drying arrangement 9. The drying of the soldering preparation ahead of the soldering station prevents a negative influence of laterally escaping soldering preparation upon the photocell surface during the contact of the metal connector 8 with the photocell.

A suction grip 10 retrieves individual photocells 11 from one of the magazines 3 with the sun side of the photocell 11 always directed upwards and moves them to a centering unit. In the centering unit, the photocells 11 are aligned relative to one of their outer edges and/or the current bus of the collector. The photocell 11 is then retrieved by a full surface vacuum pad suction device 12 and deposited on a conveyor 13. The conveyor 13 comprises a chain of plastic plates 18 resting on a carrier with said plates being preferably of Teflon or having a Teflon surface and having, in the transport direction, at least one but preferably two or more rows of circular hole-shaped openings 14 which are functionally connected to a vacuum device and by means of which the photocells 11 resting thereon are held by vacuum and are transported through the soldering station 15 up the string pick-up 16. The string pick-up 16, also a vacuum conveyor, lifts the finished strings 17 from the conveyor 13 and deposits them on the inspection station 4 where they are inspected by the inspection devices 5, 5′ for conductivity or soldering faults and by inspection device 6 for fractures or hairline breaks. Depending on the inspection result, the string 17 is then deposited in various intermediate storage locations for further processing or rejection, or transport to module assembly. The serially arranged photocells 11 are connected by crimped metal connectors 8.

Magazine 3 comprises a base plate 21 which is provided with eight through openings 19 such that every two openings 19 are positioned in a corner area of a photocell 11. Holding bolts 20 are removably affixed in the openings and are movable within the openings. The holding bolts 20 are positioned within the openings 19 depending on the size of the photocells 11. The openings 19 are dimensioned such that photocells 11 ranging in size from 150×150 mm to 300×300 mm can be accepted in magazine 3.

Because of the special design of the magazines 3 and the use of the full-surface vacuum pad pickup 12 it is possible to process photocells 11 of varying sizes on the same processing line 1 with a small configuration expenditure. An additional advantage is the transport of the photocells 11 sun face up because as a result, the centering aided by optical sensors can be of simple design. The centering by optical sensors prevents damage of the photocell edge during the centering, and at the same time supports processing of different photocells on the same processing line 1.

Completed strings are lifted from the processing line 1 by a string lift 16 operating with vacuum and are rotated 180° about their longitudinal axis. They are then taken up by a second string lifter of similar design and deposited on a receiving table 4. By using string lifters 16 operating with vacuum, this manipulation of the easily damaged strings is possible entirely without problems.

The special design of the conveyor 13 with openings 14 and a vacuum system functionally connected thereto on the one hand reliably prevents the photocells 11 from changing their position relative to one another during the transport along the processing line 1, while on the other hand enables the processing of photocells of varying dimensions.

Since both the individual photocells 11, as well as the growing, or the completed, string are moved exclusively by transport devices with holding function effected only by means of vacuum, it is also possible to process photocells 11 having lesser thicknesses than is done currently.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. An apparatus for automated processing of photocells, said apparatus comprising:
a processing line in which the photocells are removed from a supply magazine using a vacuum pad gripper, are moved to a centering unit, and are subsequently passed through a soldering device that joins said photocells in series by electrically conductive metallic connectors so as to form chains, the chains being removed by a chain lifter from the processing line,
wherein the photocells are gripped by the vacuum pad gripper and are deposited on a centering device of the centering unit that has optical sensors, wherein centering is performed relative to the outer edge of the photocell and/or a light-receiving-side mounted collector bus of the collector,
wherein a vacuum pad suction device removes the photocells from the centering device and deposits said photocells on a conveyor through openings functionally connected to a vacuum device, and
wherein the conveyor transports the photocells or the chains being formed thereof through a remaining portion of the processing line up to the removal of the completed chain by the chain lifter.

15. The apparatus according to claim 14, wherein the conveyor comprises plastic plates arranged adjacent to one another on a carrier to form an endless belt.

16. The apparatus according to claim 14, wherein the supply magazine further comprises movable holding pins positioned in guide openings, said pins holding the photocells fixedly in the magazine and being adjustable to support photocells of variable dimensions.

17. The apparatus according to claim 14, wherein the photocells range in size from 150×150 mm to 300×300 mm.

18. The apparatus according to claim 14, wherein the photocells have a plate thickness ranging from 240 μm to 100 μm.

19. The apparatus according to claim 14, wherein the photocells in the chain are linked to an adjacent photocell in the chain by two or more metallic connectors extending parallel with respect to each another.

20. The apparatus according to claim 14, wherein each metallic connector is assigned two continuous applicator rollers or flux nozzles for application of flux material on a top and a bottom side of said metallic connector.

21. The apparatus according to claim 20, wherein the application of said flux material only takes place on a side of the metallic connectors.

22. The apparatus according to claim 20, wherein after the application of the flux material, the metallic connectors are moved to a device for drying the flux material.

23. The apparatus according to claim 14, wherein ahead of, and behind, the soldering station, devices provide targeted tempering of the photocells.

24. The apparatus according to claim 14, wherein the chain lifter lifts the completed chain using vacuum suction from the conveyor and deposits said chain on a receiving table that has electrical inspection devices measuring conductivity or an optical inspection device by which fractures or hairline cracks can be detected.

25. The apparatus according to claim 14, wherein the chain lifter lifts the completed chain from the conveyor using vacuum suction and rotates said chain 180° before the chain is picked up by a similar second chain lifter and deposited on the receiving table.

26. The apparatus according to claim 14, wherein the photocells are picked up by the vacuum pad gripper with said photocells' light-receiving side facing generally upwardly.

27. The apparatus according to claim 14, wherein said plates have a surface of Teflon and, as viewed from the conveyor's longitudinal direction, have at least one opening extending therethrough and communicating functionally with a vacuum source such that the photocells placed upon the plates are held by a vacuum effect and are transported thereon to the chain lifter.

28. The apparatus according the claim 27, wherein said plates have the openings therein arranged in parallel in relation to one another.
